(19) United States
(12) Patent Application Publication
(10) Pub. No.: US 2021/0168195 A1
(43) Pub. Date: Jun. 3, 2021

(54) SERVER AND METHOD FOR CONTROLLING SERVER

(71) Applicant: Samsung Electronics Co., Ltd., Suwon-si (KR)

(72) Inventors: Jihoon O, Suwon-si (KR); Taejeoung KIM, Suwon-si (KR)

(21) Appl. No.: 16/951,398

(22) Filed: Nov. 18, 2020

(30) Foreign Application Priority Data
Nov. 28, 2019 (KR) 10-2019-0156100

(51) Int. Cl. H04L 29/08; G06N 3/08; G06N 3/04

(52) U.S. Cl. CPC H04L 67/10; G06N 3/0454; G06N 3/08

(57) ABSTRACT

A method for controlling a server is provided. The method for controlling a server includes obtaining a first neural network model including a plurality of layers, identifying a second neural network model associated with the first neural network model using metadata included in the first neural network model, based on the second neural network model being identified, identifying at least one changed layer between the first neural network model and the second neural network model, and transmitting information on the at least one identified layer to an external device storing the second neural network model.

### CROSS-REFERENCE TO RELATED APPLICATION(S)

This application is based on and claims priority under 35 U.S.C. § 119(a) of a Korean patent application number 10-2019-0156100, filed on Nov. 28, 2019, in the Korean Intellectual Property Office, the disclosure of which is incorporated by reference herein in its entirety.

### BACKGROUND

### 1. Field

The disclosure relates to a server and a method for controlling thereof. More particularly, the disclosure relates to a server for deploying only information on a changed layer in a neural network model and a method of controlling thereof.

### 2. Description of Related Art

In recent years, artificial intelligence (AI) systems have been used in various fields. An AI system is a system in which a machine learns, judges, and iteratively improves analysis and decision making, unlike an existing rule-based smart system. As the use of AI systems increases, for example, an accuracy, a recognition rate and understanding or anticipation of a user's taste may correspondingly increase. As such, existing rule-based smart systems are gradually being replaced by deep learning-based AI systems.

AI technology is composed of machine learning, for example deep learning, and elementary technologies that utilize machine learning.

Machine learning is an algorithmic technology that is capable of classifying or learning characteristics of input data. Element technology is a technology that simulates functions, such as recognition and judgment of a human brain, using machine learning algorithms, such as deep learning. Machine learning is composed of technical fields such as linguistic understanding, visual understanding, reasoning/prediction, knowledge representation, motion control, or the like.

Various fields implementing AI technology may include the following. Linguistic understanding is a technology for recognizing, applying, and/or processing human language or characters and includes natural language processing, machine translation, dialogue system, question and answer, speech recognition or synthesis, and the like. Visual understanding is a technique for recognizing and processing objects as human vision, including object recognition, object tracking, image search, human recognition, scene understanding, spatial understanding, image enhancement, and the like. Inference prediction is a technique for judging and logically inferring and predicting information, including knowledge-based and probability-based inference, optimization prediction, preference-based planning, recommendation, or the like. Knowledge representation is a technology for automating human experience information into knowledge data, including knowledge building (data generation or classification), knowledge management (data utilization), or the like. Motion control is a technique for controlling the autonomous running of the vehicle and the motion of the robot, including motion control (navigation, collision, driving), operation control (behavior control), or the like.

Recently, an environment in which a neural network model is trained and updated through a federated learning has emerged. The federated learning denotes a method of processing data by a user's individual device, instead of a central server, and updating a neural network model, for a neural network model. A neural network model may be trained through learning data in an external device such as a smart phone, only a trained neural network model may be transmitted to a central server, and the central server may update the neural network model by collecting a neural network model trained from a plurality of external devices. The central server may transmit the trained neural network model to a plurality of external devices, so that the external device may utilize the updated neural network model, and the neural network model updated by the external device may be trained again.

In the related art, in an environment such as the federated learning, update and deployment of the neural network model may frequently occur and a problem of concentrating traffic may occur. In addition, in the related art, a central server needs to deploy the entirety of the updated neural network model to each external device and thus, if capacity of the neural network model is large, there may be a problem that transmission of the neural network model is delayed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a server, when a layer of a neural network model is changed and a neural network model is updated, for transmitting only a changed layer to an external device and a method for controlling thereof.

Additional aspects will be set forth in part in the description which follows and, in part, will be apparent from the description, or may be learned by practice of the presented embodiments.

In accordance with an aspect of the disclosure, a method for controlling of a server is provided. The method includes obtaining a first neural network model including a plurality of layers, identifying a second neural network model associated with the first neural network model using metadata included in the first neural network model, based on the second neural network model being identified, identifying at least one changed layer between the first neural network model and the second neural network model, and transmitting information on the at least one identified layer to an external device storing the second neural network model.

In accordance with another aspect of the disclosure, a server is provided. The server includes a communicator including a circuitry, a memory including at least one instruction, and a processor, connected to the communicator and the memory, configured to control the server, and the processor, by executing the at least one instruction, is configured to obtain a first neural network model including a plurality of layers, identify a second neural network model associated with the first neural network model using metadata included in the first neural network model, based on the second neural network model being identified, identify at least one changed layer between the first neural network model and the second neural network model, and transmit information on the at least one identified layer to an external device storing the second neural network model, through the communicator.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a method of transmitting only information on a changed layer in a neural network model by a server to an external device or a model deploy server according to an embodiment of the disclosure;

FIG. 2 is a block diagram illustrating a configuration of a server according to an embodiment of the disclosure;

FIG. 3A is a diagram illustrating a user interface (UI) displayed on an external device according to an embodiment of the disclosure;

FIG. 3B is a diagram illustrating a UI displayed on an external device according to an embodiment of the disclosure;

FIG. 4 is a flowchart illustrating a method for controlling a server according to an embodiment of the disclosure;

FIG. 5A is a diagram illustrating a method of dividing a neural network model in layer units according to an embodiment of the disclosure;

FIG. 5B is a diagram illustrating a method of dividing a neural network model in layer units according to an embodiment of the disclosure;

FIG. 6 is a diagram illustrating a method of dividing a neural network model in layer units according to an embodiment of the disclosure;

FIG. 7 is a diagram illustrating a method of applying a controlling method of a server in a federated learning according to an embodiment of the disclosure;

FIG. 8 is a flowchart illustrating a specific controlling method of a server according to an embodiment of the disclosure;

FIG. 9 is a flowchart illustrating a method for controlling a model deploy server according to an embodiment of the disclosure;

FIG. 10 is a sequence diagram illustrating an operation between a server and an external device according to an embodiment of the disclosure;

FIG. 11A is a sequence diagram illustrating an operation among a server, an external device, and a model deploy server according to an embodiment of the disclosure; and

FIG. 11B is a sequence diagram illustrating an operation among a server, an external device, and a model deploy server according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

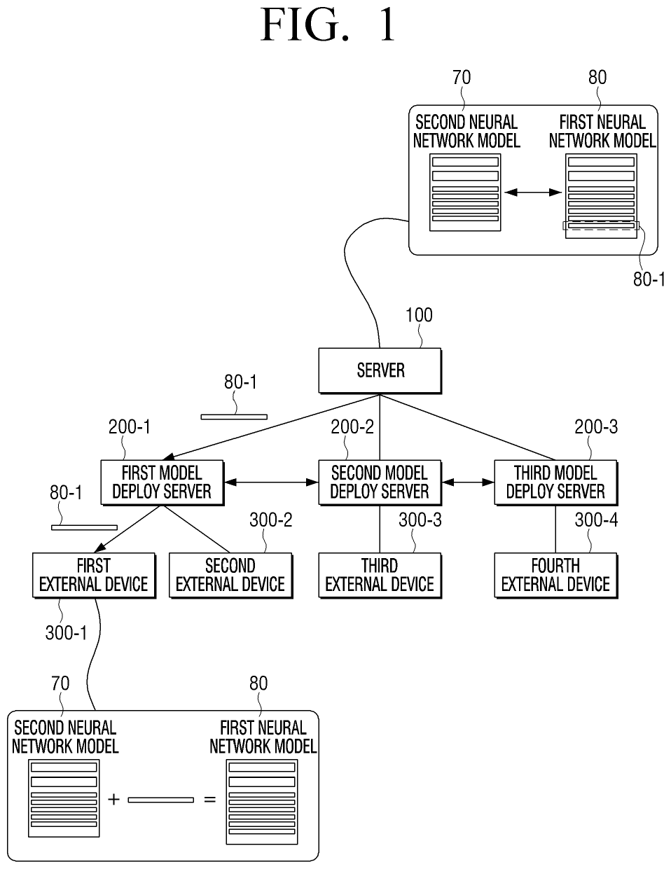

FIG. 1 is a diagram illustrating a method of transmitting, to an external device or a model deploy server, only information on a changed layer in a neural network model by a server according to an embodiment of the disclosure.

Referring to FIG. 1, a server 100 according to the disclosure is the server 100 for identifying only information about a changed layer in a neural network model, and transmitting information about the changed layer to a model deploy server 200-1 to 200-3 and a plurality of external devices 300-1 to 300-4. The server 100 is not limited to a cloud, or the like, and may also be implemented as a base station such as a mobile edge computing (MEC), a home server of a smart home, an Internet of Things (IoT) hub, or the like.

The server 100 may obtain a first neural network model 80 that includes a plurality of layers. The first neural network model 80 is a neural network model from which, when the input data is entered, output data corresponding thereto is output, and for example, may include a speech recognition model, an object recognition model, or the like. When the utterance data of a user is input as the input data, the voice recognition model may output information corresponding to the user's utterance as output data. When the image data is input as the input data, the object recognition model may output information on an object included in the image as output data.

The neural network model may be composed of a plurality of neural network layers. Each layer has a plurality of weight values, and performs a layer operation through calculation of a previous layer and an operation of a plurality of weights. Examples of neural networks may include, but are not limited to, a convolutional neural network (CNN), a deep neural network (DNN), a recurrent neural network (RNN), a Restricted Boltzmann Machine Task (RBM), a deep belief network (DBN), a bidirectional deep neural network (BRDNN), and deep Q-networks, and the neural network in the disclosure is not limited to the above-described example except when specified.

The first neural network model 80 may be a neural network model which is obtained by changing and updating at least one layer of the second neural network model 70.

As an embodiment, the first neural network model 80 with at least one changed layer may be obtained, as a hyper parameter for at least one layer included in the second neural network model 70 is changed. The hyper parameter may be a parameter such as a learning rate of a neural network model and may have to be directly changed by a user, unlike a parameter (e.g., weight, bias, or the like) which is automatically updated as the neural network is trained.

In another embodiment, as a layer is added in the second neural network model 70, a first neural network having a changed layer may be obtained. For example, the second neural network model 70 may be trained from each of the plurality of external devices so that a gradient of the second neural network model 70 may be updated as a result of the learning. The plurality of external devices may transmit the updated gradient of the second neural network model 70 to the server 100 or other external servers. The server 100 or other external servers receiving the plurality of gradient may calculate an average for the plurality of gradients and add a layer associated with the calculated gradient to the second neural network model 70 to update the second neural network model 70 to the first neural network model 80.

In the above-described embodiments, hyper parameter of at least one layer included in the second neural network model 70 may be changed, or a new layer may be added to the second neural network model 70, thereby changing at least one layer included in the second neural network, but the embodiment is not limited thereto, and changing the neural network model may include deleting at least one layer included in the neural network model, and by various methods of changing a layer of a neural network model, at least one layer included in the second neural network model 70 may be changed, and the first neural network model 80 may be obtained.

According to an embodiment, the server 100 may directly generate the first neural network model 80 which is obtained by changing at least one layer of the second neural network model 70 or receive the first neural network model 80 from an external server or an external device to obtain the first neural network model 80.

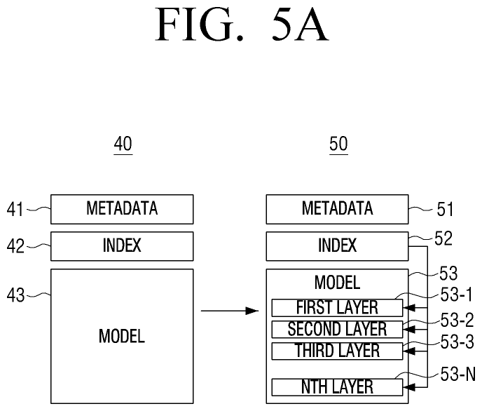

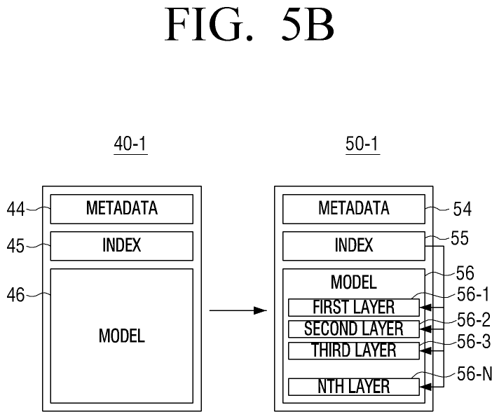

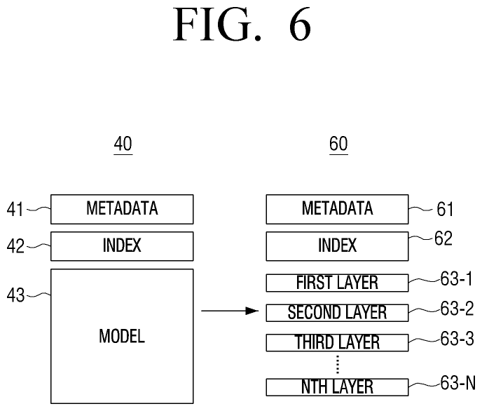

In one embodiment, the first neural network model 80 may be configured as a metadata file, an index file, and files for each of at least one layer. In another embodiment, the first neural network model 80 may consist of a metadata file, an index file, and a model file, and the model file may include at least one layer divided through an offset table included in the index file. That is, the first neural network model 80 is a neural network model divided as being transmittable by each layer, and will be described in detail with reference to FIGS. 5A, 5B, and 6.

The server 100 may identify the second neural network model 70 associated with the first neural network model 80 by using the metadata included in the first neural network model 80. That is, the server 100 may identify whether the second neural network model 70 is present in the server 100 by using the metadata file included in the first neural network model 80 which is obtained by changing at least one layer in the second neural network model 70. However, the server 100 may identify whether the second neural network model 70 is present in the server 100 using the metadata file and the index file included in the first neural network model 80, without limitation.

If the second neural network model 70 is identified as not being present in the server 100, the server 100 may transmit the entirety of the first neural network model 80 to at least one of the plurality of external devices 300-1 to 300-4. The external devices 300-1 to 300-4 may be electronic devices such as smart phones, and neural network models may be trained by the external devices 300-1 to 300-4. According to an embodiment, by using a neural network model in the external devices 300-1 to 300-4, the neural network model may be trained using a method such as reinforcement learning through which learning can be performed automatically, but the embodiment is not limited thereto and the neural network model can be trained through various methods.

When the second neural network model 70 is identified as being present in the server 100, the server 100 may identify the at least one changed layer between the first neural network model 80 and the second neural network model 70. Specifically, the at least one changed layer can be identified by identifying a hash value for at least one layer file changed through an index file included in the first neural network. This will be described in detail with reference to FIGS. 5A, 5B, and 6.

If at least one changed layer between the first neural network model 80 and the second neural network model 70 is identified, the server 100 may transmit information about the at least one identified layer to the first external device 300-1 storing the second neural network model 70. The server 100, without limitation, may transmit information about the at least one identified layer to at least one of the plurality of model deploy servers 200-1 to 200-3, and the first external device 300-1 may receive information about at least one layer identified from the first model deploy server 200-1 designated in the first external device 300-1. The model deploy server is a server for preventing overload of the server 100 in deploying (transmitting) of the neural network model by the server 100. Specifically, the plurality of model deploy servers 200-1 to 200-3 may store the entirety of the first neural network model 80 and the second neural network model 70, or may only store information about at least one changed layer in the second neural network model 70. The plurality of model deploy servers 200-1 to 200-3 may transmit the entirety of the first neural network model 80 to an external device designated to each of the plurality of model deploy servers 200-1 to 200-3, or may transmit information about the at least one changed layer. Referring to FIG. 1, the model deploy server designated in the first external device 300-1 and the second external device 300-2 is the first model deploy server 200-1, the model deploy server designated in the third external device 300-3 is the second model deploy server 200-2, and the model deploy server designated in the fourth external device 300-4 is the third model deploy server 200-3. According to an embodiment, a plurality of external devices may receive the entirety of the neural network model from the model deploy server designated to each of the plurality of external devices or may receive only information 80-1 about the changed layer from the neural network model.

If the first external device 300-1 requests the information 80-1 on the changed layer to the first model deploy server 200-1, in a first embodiment, if the changed layer is not stored in the first model deploy server 200-1, the first model deploy server 200-1 may receive the information 80-1 on the changed layer from the server 100 and transmit the received information 80-1 to the first external device 300-1. That is, the first embodiment may be a case in which, with the request for the information 80-1 regarding the changed layer by the first external device 300-1 as being the first request, the server 100 may first transmit the information 80-1 regarding the changed layer to the first model deploy server 200-1.

In a second embodiment, if the information on the changed layer is stored in the first model deploy server 200-1, the first model deploy server 200-1 may transmit the information 80-1 on the changed layer to the first external device 300-1. That is, in the second embodiment, with the request of the information 80-1 on the changed layer by the second external device 300-2 designated in the first model deploy server 200-1 as being the first, the server 100 may transmit the information 80-1 on the already changed layer to the first model deploy server 200-1.

In a third embodiment, if the information about the changed layer is not stored in the first model deploy server 200-1, the first model deploy server 200-1 may receive information 80-1 from at least one of the second model deploy server 200-2, the third model deploy server 200-3, and transmit the information 80-1 for the changed layer to the first external device 300-1. That is, in the third embodiment, the information 80-1 for the changed layer from the external device other than the external device designated by the first model deploy server 200-1 may be requested initially, and transmit the information 80-1 on the changed layer to the model deploy server designated by the external device requesting the information 80-1 for the changed layer by the server 100. In this example, the first model deploy server 200-1 may receive the information 80-1 for the changed layer from the first model deploy server 200-1 that transmitted the information 80-1 for the changed layer of the server 100, and transmit the received layer to the first external device 300-1. In the first to third embodiments described above, when the first external device 300-1 requests the information 80-1 for the changed layer to the first model deploy server 200-1, the first external device 300-1 receives the information 80-1 for the changed layer from the first model deploy server 200-1, but is not limited thereto. If at least one changed layer is identified by the server 100 between the first neural network model 80 and the second neural network model 70, the server 100 may transmit the information 80-1 for at least one changed layer to the first external device 300-1 or the first model deploy server 200-1 without requesting information 80-1 for the changed layer of the first external device 300-1. The first external device 300-1 may receive information 80-1 for the changed layer at a predetermined periodic interval (e.g., one week) from the first model deploy server 200-1 or the server 100.

In the embodiments above, if at least one changed layer is identified between the first neural network model 80 and the second neural network model 70, the server 100 transmits the information 80-1 on the changed layer to the external device or the model deploy server, but the embodiment is not limited thereto.

According to one embodiment, if the number of changed layers is greater than or equal to a predetermined value (e.g., one third or more of the total number of layers), the server 100 may transmit the entirety of the first neural network model 80 to at least one external device among the plurality of external devices 300-1 to 300-4 or to at least one of the plurality of model deploy servers 200-1 to 200-4. That is, if the number of changed layers is equal to or greater than a preset value by comparing the first neural network model 80 and the second neural network model 70, it may be identified that update of the entirety of the second neural network model 70 is performed, and the server 100 may transmit the entirety of the first neural network model 80 to at least one external device of the plurality of external devices 300-1 to 300-4 or to at least one of the plurality of model deploy servers 200-1 to 200-4.

In addition, according to another embodiment, the server 100 may transmit the changed layer to at least one external device among the plurality of external devices 300-1 to 300-4 or to at least one of the plurality of model deploy servers 200-1 to 200-4, only if the first neural network model 80 has improved performance over the second neural network model 70, through the changed layer. To be specific, the server 100 may compare an accuracy and loss values of the first neural network model 80 and the second neural network 70. The accuracy and loss values of the neural network model are indicative of the performance of the neural network model, and the higher the accuracy, the lower the loss value, and the better the performance of the neural network model. As a result of the comparison, if the accuracy of the first neural network model 80 is higher than the accuracy of the second neural network model 70 and the loss value of the first neural network model 80 is lower than the loss value of the second neural network model 70, the server 100 may transmit the changed layer to at least one external device of the plurality of external devices 300-1 to 300-4 or to at least one of the plurality of model deploy servers 200-1 to 200-4.

The first external device 300-1 receiving the changed layer may update the second neural network model 70 as the first neural network model 80 based on the received layer. The first external device 300-1 may update the second neural network model 70 as the first neural network model 80 by identifying the changed layer in the existing layer of the second neural network model 70 and changing the identified layer to the changed layer based on the information 80-1 for the changed layer.

According to various embodiments as described above, when the server 100 deploys (transmits) the updated neural network model, the amount of the file transmitted by deploying (transmitting) only the information about the changed layer is reduced, thereby shortening the time required for deployment and training of the neural network model. An overload to the server 100 may be prevented by using the model deploy server.

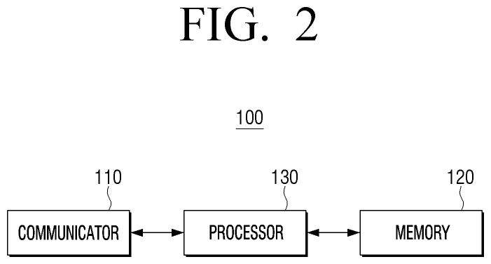

FIG. 2 is a block diagram illustrating a configuration of a server according to an embodiment of the disclosure.

Referring to FIG. 2, the server 100 may include a communicator 110, a memory 120, and a processor 130. The configurations shown in FIG. 2 are examples for implementing embodiments, and appropriate hardware/software configurations that would be apparent to those skilled in the art may be further included in the server 100.

The communicator 110 is configured to communicate with various types of external devices according to various types of communication methods. The communicator 110 may include a wireless fidelity (Wi-Fi) chip, a Bluetooth chip, a wireless communication chip, a near field communication (NFC) chip, and the like. The processor 130 performs communication with various external devices using the communicator 110.

The Wi-Fi chip and a Bluetooth chip performs communication using Wi-Fi method, Bluetooth method, or the like. When the Wi-Fi chip or the Bluetooth chip is used, various connection information such as a service set identifier (SSID) and a session key may be transmitted and received first, and communication information may be used to transmit and receive various information. The wireless communication chip refers to a chip that performs communication according to various communication standards such as Institute of Electrical and Electronics Engineers (IEEE), Zigbee, 3rd Generation (3G), Third Generation Partnership Project (3GPP), Long Term Evolution (LTE), or the like. A near field communication (NFC) chip means a chip operating in NFC using, for example, a 13.56 megahertz (MHz) band among various radio frequency identification (RF-ID) frequency bands such as 135 kHz, 13.56 MHz, 433 MHz, 860 to 960 MHz, 2.45 gigahertz (GHz), or the like.

The communicator 110 may communicate with an external server, an external device, a model deploy server, or the like. Specifically, the communicator 110 may receive a first neural network model from an external server or an external device. The communicator 110 can transmit the first neural network model to an external device and a model deploy server or transmit information on at least one layer of the layers included in the first neural network model to an external device and a model deploy server.

The memory 120 may store a command or data related to at least one other elements of the server 100. The memory 120 is accessed by the processor 130 and reading/writing/modifying/deleting/updating of data by the processor 130 may be performed. In the disclosure, the term memory may include the memory 120, read-only memory (ROM) in the processor 130, random access memory (RAM), or a memory card (for example, a micro secure digital (SD) card, and a memory stick) mounted to the server 100.

According to the disclosure, the second neural network model may be stored in the memory 120. When the first neural network model is obtained, the obtained first neural network model may be stored in the memory 120.

The processor 130 may be configured with one or a plurality of processors. At this time, one or a plurality of processors may be a general purpose processor, such as a central processing unit (CPU), an application processor (AP), or the like, a graphics-only processor such as graphics processing unit (GPU), visual processing unit (VPU), or the like, or an AI-dedicated processor such as neural network processing unit (NPU).

The one or more processors control the processing of the input data according to a predefined operating rule or neural network model stored in the memory. The predefined operating rule or the neural network model is made through learning. Here, that the neural network model is made through learning may refer that the learning algorithm is applied to a plurality of learning data, so that a predefined operating rule or neural network model of a desired characteristic is generated. The learning may be performed in a device itself in which AI according to the disclosure is performed, and may be implemented through a separate server/system.

The processor 130, electrically connected to the memory 120, may control overall operation of the server 100. The processor 130 may control the server 100 by executing at least one instruction stored in the memory 120.

The processor 130 may obtain a first neural network model that includes a plurality of layers by executing at least one instruction stored in the memory 120. The first neural network model may be a neural network model in which, if data is input, data corresponding to the input data is output, and the first neural network model may be a neural network model in which at least one layer is changed in a second neural network model.

The first neural network model and the second neural network model may consist of a model meta data file, an index file, and files for each of the at least one layer. The first neural network model and the second neural network model may be composed of a model meta data file, an index file, and a model file, and the model file can include at least one layer divided through an offset table included in the index file. That is, the first neural network model and the second neural network model may be neural network models that are capable of transmission on each layer.

If the first neural network model is obtained, the processor 130 may use the metadata included in the first neural network model to identify a second neural network model associated with the first neural network model. Since the first neural network model is a neural network model in which only at least one layer of the second neural network model is changed and thus, the metadata of the first neural network model and the second neural network model may be similar to each other. Accordingly, the processor 130 may use the metadata file included in the first neural network model to identify whether the second neural network model of which at least one layer is different from the first neural network model is stored in the server 100. However, the processor 130 may identify a second neural network model associated with the first neural network model using the metadata file and the index file included in the first neural network model.

When the second neural network model is identified, the processor 130 may identify the at least one changed layer between the first neural network model and the second neural network model. That is, when the second neural network is stored in the server 100, the processor may compare the second neural network model with the first neural network model to identify the at least one changed layer. Specifically, the processor 130 may identify the at least one changed layer by identifying a hash value for at least one layer that has changed through an index file included in the first neural network model.

If the second neural network model is not identified, the processor 130 may transmit the entirety of the first neural network model to the external device. That is, if the second neural network model is not stored in the server 100, it is identified that the first neural network model is a new neural network model and thus, the processor 130 may transmit the entirety of the first neural network model to the external device.

If at least one changed layer between the first neural network model and the second neural network model is identified, the processor 130 may transmit information about the identified at least one layer to an external device that is storing the second neural network model. The processor 130 may transmit information on the at least one changed layer to an external device storing the second neural network model to update the second neural network model to the first neural network model based on information about the at least one layer received by the external device.

The information on the at least one identified layer may include the metadata file of the first neural network model, an index file, and a file related to at least one changed layer. A detail of the information on the at least one identified layer will be described in detail with reference to FIGS. 5A, 5B, and 6.

According to one embodiment, the processor 130 may transmit information on the at least one identified layer to at least one of the plurality of model deploy servers. The external device may then receive information on at least one layer identified from the model deploy server specified in the external device. Specifically, the plurality of model deploy servers may store the entirety of the first neural network model and the second neural network model, or may only store the at least one changed layer in the second neural network model. The plurality of model deploy servers can transmit the entirety of the first neural network model to an external device designated to each of the plurality of model deploy servers, or may transmit information about the changed at least one layer. According to one embodiment, the plurality of external devices may receive the entirety of the neural network model from a model deploy server designated in each of the plurality of external devices, or only receive information about the changed layer in the neural network model.

According to one embodiment, an external device may request an update for the second neural network model to a designated model deploy server or the server 100. To be specific, the external device may request information on the at least one changed layer associated with the second neural network model to the designated model deploy server, and if the server 100 may obtain the updated first neural network model in the second neural network model to identify at least one changed layer, the processor 130 may transmit information indicating that the second neural network model is updated to the plurality of model deploy servers through the communicator 110, and may transmit, to the external device 300, information indicating that the model deploy server designated in the external device 300 storing the second neural network mode, among the plurality of model deploy servers, is updated. The processor 130 may directly transmit information indicating that the second neural network model has been updated through the communicator 110 to the external device 300 storing the second neural network model.

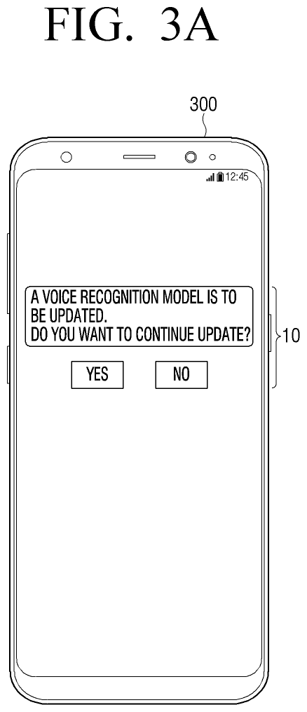

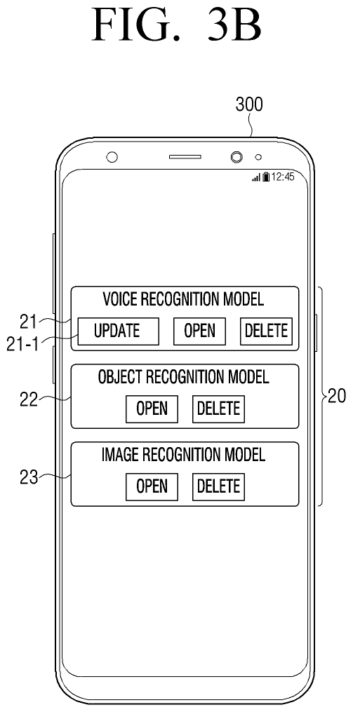

FIG. 3A is a diagram illustrating a user interface (UI) displayed on an external device according to an embodiment of the disclosure.

Referring to FIG. 3A, when the external device 300 receives information indicating that the speech recognition model has been updated, a user interface (UI) 10 indicating information that the voice recognition model has been updated may be displayed on the external device 300.

FIG. 3B is a diagram illustrating a UI displayed on an external device according to an embodiment of the disclosure.

Referring to FIG. 3B, a UI 20 for managing a plurality of neural network models can be displayed on an external device, and when the external device 300 receives information indicating that the voice recognition model has been updated, in a panel 21 an UI element 21-1 for updating the voice recognition model can be further displayed on the UI 20. The UI 20 may further include a panel 22 for opening or deleting an object recognition model and a panel 23 for opening or deleting an image recognition model.

Referring to FIGS. 3A and 3B, the second neural network model is updated to the first neural network model through the UI displayed on the external device 300, but is not limited thereto. If at least one changed layer between the first neural network model and the second neural network model is identified at the server 100, the processor 130 may automatically transmit information about at least one changed layer to the external device or the model deploy server without request by the external device. The external device may receive information about whether the second neural network model has been updated at a predetermined periodic interval (e.g. one week) from the model deploy server or the server 100 designated in the external device.

If the external device makes a request for at least one changed layer to the model deploy server designated in the external device, and the information about the changed layer is not stored in the model deploy server designated in the external device, the model deploy server designated in the external device can receive information about the changed layer from the server 100 and transmit the information to the external device. Alternatively, if the information for the changed layer is stored in the deploy server designated in the external device, the model deploy server designated at the external device may transmit information about the modified layer to the external device. Alternatively, if the information for the changed layer is not stored in the model deploy server specified in the external device, the model deploy server designated at the external device may receive information about the changed layer from at least one of the other model deploy servers and transmit the received information to the external device.

In the embodiment, the at least one changed layer between the first neural network model and the second neural network model is identified, the processor 130 may transmit the information on the changed layer to an external device or a model deploy server through the communicator 110, but the embodiment is not limited thereto.

According to an embodiment, when the number of changed layers is greater than or equal to a preset value, the processor 130 may transmit the entirety of the first neural network model through the communicator 110 to at least one external device of the plurality of external devices or to at least one of the plurality of model deploy servers. That is, if the number of changed layers by comparing the first neural network model and the second neural network model is equal to or greater than a preset value, the processor 130 may identify that update of the entirety of the second neural network model is done, and may transmit the entirety of the first neural network model through the communicator 110 to at least one external device of the plurality of external devices or to at least one of the plurality of model deploy servers.

According to another embodiment, the processor 130 may transmit the changed layer through the communicator 110 to at least one external device of the plurality of external devices or a model deploy server among the plurality of model deploy servers only when the first neural network model has improved performance compared to the second neural network model through the changed layer. Specifically, the processor 130 may compare the accuracy and loss values of the first neural network model and the second neural network model. The accuracy and loss values of the neural network model are indicators indicative of the performance of the neural network model, the higher the accuracy, the lower the loss value, the better the performance of the neural network model. As a result of the comparison, if the accuracy of the first neural network model is higher than the accuracy of the second neural network model, and the loss value of the first neural network model is lower than the loss value of the second neural network model, the processor 130 can transmit the changed layer to at least one external device of the plurality of external devices or to at least one of the plurality of model deploy servers.

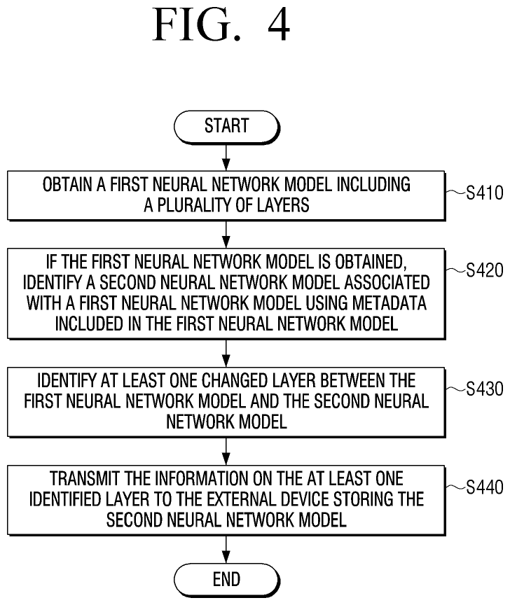

FIG. 4 is a flowchart illustrating a method for controlling a server according to an embodiment of the disclosure.

Referring to FIG. 4, the server 100 may obtain a first neural network model including a plurality of layers in operation S410. The first neural network model according to the disclosure may consist of a model metadata file, a model index file, and files for each of the at least one layer. The first neural network model may be composed of a model metadata file, a model index file, and a model file, and the model file may include at least one layer divided through an offset table included in the model index file. That is, the first neural network model may be a neural network model transmittable for each layer.

The server 100 may identify a second neural network model related to the first neural network model using the metadata included in the first neural network model in operation S420. Specifically, since the first neural network model is a neural network model in which at least one layer of the second neural network model is changed, the metadata of the first neural network model and the second neural network model can be similar to each other. The server 100 may identify whether the second neural network model of which at least one layer is different from the first neural network model is stored in the server 100 using the metadata file included in the first neural network model. However, the server 100 may identify a second neural network model associated with the first neural network model using the metadata file and the index file included in the first neural network model.

If the second neural network model is identified, the server 100 may identify at least one changed layer between the first neural network model and the second neural network model in operation S430. If the second neural network is stored in the server 100, the server 100 may identify the at least one changed layer by comparing the second neural network model and the first neural network model. The server 100 may identify at least one changed layer by identifying a hash value of at least one changed layer through the index file included in the first neural network model.

If the at least one changed layer between the first neural network model and the second neural network model is identified, the server 100 may transmit the information on the at least one identified layer to the external device storing the second neural network model in operation S440. The server 100 may transmit information on at least one changed layer to the external device storing the second neural network model and update the second neural network model as the first neural network model based on the received information the at least one layer. The identified information on at least one layer may include the metadata file, index file, and the file associated with at least one changed layer of the first neural network model.

By the various embodiments above, when the server 100 deploys (transmits) the updated neural network model, the time required for deployment and training of the neural network model may be shortened.

FIGS. 5A and 5B are diagrams illustrating a method of dividing a neural network model in layer units according to various embodiments of the disclosure.

Referring to FIG. 5A, a related-art neural network model 40 may include metadata 41, index data 42, and model data 43. The metadata 41 includes structured data information and may include information about the data for identifying the neural network model 40. Specifically, the server 100 may use the metadata included in the first neural network model to identify a second neural network model associated with the first neural network model. The index data 42 may be a file for identifying the configuration of the model data 43. The model data 43 may include information (e.g., weight, bias) for a plurality of layers.

The related-art neural network model 40 may consist of a file including the metadata 41, a file including the index data 42, and a file including the model data 43. According to an embodiment, a neural network model 50 dividable by layer units can be obtained through the related-art neural network model 40. The neural network model 50 may be the neural network model 50 in which a file including the related-art model data 43 includes model data 53 including a plurality of layers 53-1 to 53-N that are transmittable in layer units. Through an offset table included in the file including the index data 52 of the neural network model 50, the server 100 may transmit only information about the changed layer in the neural network model 50 to an external device or a model deploy server. That is, the neural network model 50 can be a neural network model that can be transmitted in layer units.

Referring to FIG. 5B, the related-art neural network model 40-1 may be configured as a single file, and the neural network model 40-1 may include the metadata 44, the index data 45, and the model data 46. According to the disclosure, the neural network model 50-1 which is dividable by layer units may be obtained through the related-art neural network model 40-1. The neural network model 50-1 may be a neural network model 50-1 that is obtained by the related-art model data 46 transforming to the model data 56 including a plurality of layers 56-1 to 56-N transmittable by layer units. Through an offset table included in the index data 55 of the neural network model 50-1, the server 100 can only transmit information about the changed layer in the neural network model 50-1 to the external device or the model deploy server. That is, the neural network model 50-1 can be a neural network model that can be transmitted in layer units.

Through the file including the index data 52 of FIG. 5A and the offset table included in the index data 55 of FIG. 5B, the file including the model data 43 or at least one layer in the model data 56 may be managed, and when at least one layer of the neural network model 50, 50-1 is changed, the server 100 may identify at least one changed layer by identifying a hash value for the at least one changed layer through the file including the index data 52 or the offset table of the index data 55. The hash value for a layer according to the disclosure may be a result value of a hash function for each layer, and through the hash value for the layer, the server 100 may identify whether at least one layer is present and whether at least one layer has been changed (updated). That is, according to the disclosure, the hash value is applied to each layer, and when the server 100 identifies at least one layer via the hash value applied to each layer to identify at least one layer, the server 100 does not need to compare the entire layers included in the neural network model.

If the at least one changed layer is identified, the server 100 may extract the data for the changed layer through the offset table from a file including the model data 53 or the model data 56 and may transmit the extracted data, index data 52, 55 and the metadata 51, 54 to an external server or model deploy server. That is, when the server 100 transmits information about the changed layer to an external device or a model deploy server using the neural network model 50, 50-1 according to FIGS. 5A and 5B, the information about the changed layer according to the disclosure may include data for the changed layer extracted through the offset table, index data, and metadata.

Referring to FIG. 5B, in one embodiment, if the at least one changed layer is in plural, the server 100 may transmit metadata 54 and index data 55 to an external server or a model deploy server, along with information about the plurality of changed layers. For example, if the changed layer in the neural network model 50-1 of FIG. 5B is a second layer 56-2 and a third layer 56-3, the server 100 may extract the data about the second layer 56-2 and the third layer 56-3 from the model data 56, and may transmit the data for the extracted second layer 56-2 and the third layer 56-3 to the external server or the model deploy server along with the metadata 54 and the index data 55.

FIG. 6 is a diagram illustrating a method of dividing a neural network model in layer units according to an embodiment of the disclosure.

Referring to FIG. 6, through a neural network model 60 in which a model data 43 of the former neural network model 40 is converted to files 63-1 to 63-N for each of the plurality of layers, the server 100 may transmit only information on the changed layer to the external device or the model deploy server. That is, the converted neural network model 60 may be a neural network model in which files are divided by layer units and transmittable by layer units.

Through the index data file 62, it may be identified which hash value each layer file 63-1 to 63-N may have. If the at least one changed layer is identified through the index data file 62, the server 100 may transmit the file on the changed layer, the index data file 62, and the metadata file 61 to the external server or the model deploy server.

Using the neural network model 60 according to FIG. 6, if the server 100 transmits the information on the changed layer to an external device or the model deploy server, the information on the changed layer may include the file for the changed layer, index data file, and metadata file.

Referring to FIG. 6, in one embodiment, if the at least one changed layer is in plural, the server 100 may transmit the metadata file 61 and the index data file 62 to an external server or model deploy server, along with a file for the plurality of changed layers. For example, in the neural network model 60 of FIG. 6, if the changed layer is a second layer 6-2 and a third layer 63-3, the server 100 may identify a hash value for at least one layer that has changed through the index data file 62, and transmit the identified second layer 63-2 file and the third layer 63-3 file along with the metadata file 61 and the index data file 62 to an external server or model deploy server.

Through the neural network models 50, 50-1, and 60 as illustrated in FIGS. 5A, 5B, and 6, the server 100 may transmit only the information on the changed layer to the external device or the model deploy server.

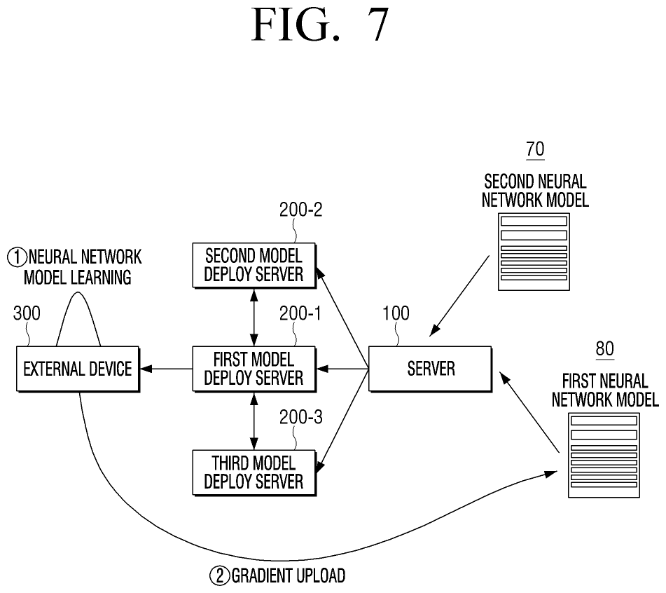

FIG. 7 is a diagram illustrating a method of applying a controlling method of a server in a federated learning according to an embodiment of the disclosure.

Referring to FIG. 7, the second neural network model 70 may be trained by the external device 300 to obtain a first neural network model 80 in which at least one layer is changed in the second neural network model 70 through the trained second neural network model 70. FIG. 7 shows the external device 300 in which the learning of the neural network model is performed and the federated learning in which an update of the neural network model is performed through the server 100 for managing and updating the learned neural network model. The federated learning is a method of processing data and updating a neural network model by the user's individual device, rather than a central server, for a neural network model. Specifically, a neural network model may be trained through learning data in an external device such as a smart phone, and only a trained neural network model is transmitted to a central server, and a central server can update the neural network model by collecting a neural network model trained from a plurality of external devices.

When the external device 300 obtains the second neural network model, the external device 300 may train the second neural network model (\textcircled{1}). For example, the external device 300 may be a user device such as a smartphone, and the second neural network model may be trained by the user. As an embodiment, by using the neural network model, the second neural network model may be trained through the reinforcement learning capable of automatic learning, but the embodiment is not limited thereto, and the second neural network model may be trained through the external device by various methods.

When the second neural network model is trained through the external device 300, a gradient for the second neural network model may be updated. The gradient denotes an incline indicating a point at which the loss value of the neural network model is a minimum, and the less the loss value of the neural network model, the better the performance of the neural network model. The gradient may be an indicator indicating the learning result of the neural network model.

The external device 300 may transmit the updated gradient to the server 100 or the external server (not shown) (\textcircled{2}). The server 100 or an external server (not shown) receiving the updated gradient may change at least one layer in the second neural network model 70 based on the updated gradient to generate the first neural network model 80. In one embodiment, a layer in which the updated gradient is reflected in the second neural network model 70 may be added to obtain the first neural network model 80. In one embodiment, when the server 100 or the external server obtains a plurality of updated gradients for a second neural network model from a plurality of external devices, a layer in which the average value of the obtained plurality of gradient is reflected may be added to the second neural network model 70 so that the first neural network model 80 may be obtained. When the first neural network model 80 is generated from an external server, the external server may transmit the first neural network model 80 to the server 100 so that the server 100 can obtain the first neural network model 80 from the external server. However, the embodiment is not limited thereto, and at least one layer of the existing layers included in the updated gradient for the second neural network model 70 may be changed.

If the server 100 obtains the first neural network model, the server 100 may identify the second neural network model associated with the first neural network model using the metadata included in the first neural network model.

If the second neural network model associated with the first neural network model is identified, the server 100 may identify the at least one changed layer between the first neural network model and the second neural network model.

If the at least one changed layer is identified, the server 100 may transmit information on the at least one changed layer to at least one of the first model deploy server 200-1, the second model deploy server 200-2, and the third model deploy server 200-3. The information on the at least one changed layer may include the metadata file, index file, and the files on the changed layer, associated with the first neural network model 80.

The external device 300 may request the information on the changed layer to the first model deploy server 200-1 to update the second neural network model. If the information on the changed layer is stored in the first model deploy server 200-1 designated in the external device 300, the first model deploy server 200-1 may transmit information on the changed layer to the external device 300, in response to the request of the external device 300.

If the information on the changed layer is not stored in the first model deploy server 200-1 designated at the external device 300, the first model deploy server 200-1 may request information on the changed layer to at least one server among the second model deploy server 200-2, the third model deploy server 200-3, and the server 100, to receive information on the changed layer. The first model deploy server 200-1 may transmit information on the changed layer to the external device 300, in response to the request of the external device 300.

Upon receiving information of the changed layer by the external device 300, the external device 300 may update the second neural network model 70 as the first neural network model 80 based on the information on the changed layer.

The external device 300 may train the first neural network model 80 (\textcircled{1}), update the gradient for the trained first neural network model 80, and transmit the updated gradient to the server 100 or the external server (\textcircled{2}).

By the embodiments described above, in an environment where update or deployment of the neural network model frequency occurs as the federated learning, the server 100 may deploy only the information on the changed layer associated with the neural network model, thereby shortening time required for deployment and learning of the neural network model.

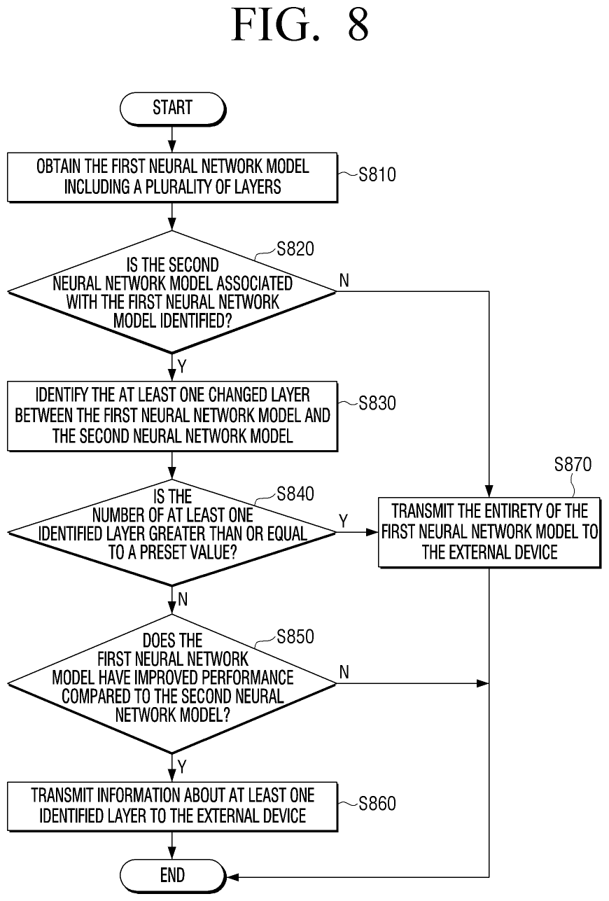

FIG. 8 is a flowchart illustrating a specific controlling method of a server according to an embodiment of the disclosure.

Referring to FIG. 8, the server 100 may obtain the first neural network model including a plurality of layers in operation S810. The first neural network model may be a neural network model which is divided to be transmittable by layers.

The server 100 may identify the second neural network model associated with the first neural network model in operation S820. For example, the server 100 may identify whether the second neural network model associated with the first neural network model is stored in the server 100 using the metadata included in the first neural network model. If the second neural network model is not identified, the server 100 may transmit the entirety of the first neural network model to the external device in operation S870.

If the second neural network model is identified, the server 100 may identify the at least one changed layer between the first neural network model and the second neural network model. That is, when the second neural network is stored in the server 100, the server 100 can compare the second neural network model with the first neural network model to identify the at least one changed layer. Specifically, the server 100 can identify the at least one changed layer by identifying a hash value for at least one changed layer through an index file included in the first neural network model in operation S830.

If at least one changed layer between the first neural network model and the second neural network model is identified, the server 100 can identify whether the number of at least one identified layer is greater than or equal to a preset value in operation S840. That is, if the number of changed layers is equal to or greater than a preset value by comparing the first neural network model and the second neural network model in operation S840-Y, it may be identified that update of the entirety of the second neural network model is performed and the server 100 can transmit the entirety of the first neural network model to the external device in operation S870.

If the number of changed layers is not greater than or equal to the predetermined value in operation S840-N, the server 100 can identify whether the first neural network model has improved performance compared to the second neural network model in operation S850. The server 100 can transmit information about the changed layer to the external device only when the first neural network model has improved performance compared to the second neural network model through the changed layer in operation S860. Specifically, the server 100 can compare the accuracy and loss values of the first neural network model and the second neural network model. The accuracy and loss value of a neural network model are indicative of the performance of a neural network model, and the higher the accuracy, the lower the loss value, the better the performance of the neural network model. As a result of the comparison, if the accuracy of the first neural network model is higher than the accuracy of the second neural network model, and the loss value of the first neural network model is lower than the loss value of the second neural network model, the server 100 can transmit information about the changed layer to the external device.

When the performance of the first neural network model is not improved over the second neural network model through the changed layer in operation S850-N, the server may not transmit the information on the changed layer to an external device.

In the embodiments described above, the server 100 transmits the information on the changed layer to the external device, but the embodiment is not limited thereto, and may transmit the information on the changed layer to the model deploy server.

By the various embodiments as described above, the server 100 may transmit information on the changed layer to the external device, only when the number of changed layers in the neural network model is not over the preset value, or the performance of the neural network model is improved by the changed layer, thereby shortening the time required for deployment and learning of the neural network model.

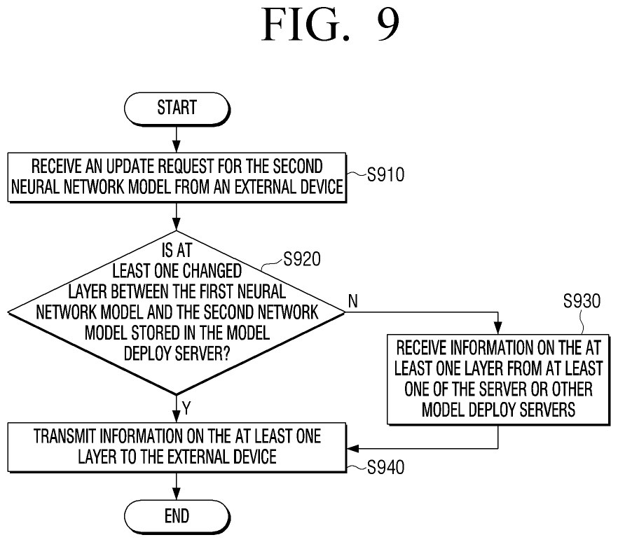

FIG. 9 is a flowchart illustrating a method for controlling a model deploy server according to an embodiment of the disclosure.

Referring to FIG. 9, the model deploy server may receive an update request for the second neural network model from an external device in operation S910. As illustrated in FIGS. 3A and 3B, a request for update of the neural network model may be received at the model deploy server from the external device through the UIs 10, 20 displayed in the external device.

Upon receiving the request for update of the second neural network model from the external device, the model deploy server may identify whether at least one changed layer between the first neural network model and the second network model is stored in the model deploy server in operation S920.

When the at least one changed layer between the first neural network model and the second neural network model is not stored in the model deploy server in operation S920-N, the model deploy server may receive information on the at least one changed layer from at least one of the server 100 or other model deploy servers S930. The model deploy server may transmit information on the at least one changed layer to the external device in operation S940.

If at least one changed layer between the first neural network model and the second neural network model is not stored in the model deploy server, the model deploy server may receive information about the changed layer from the server 100. The above embodiment may be the case where the external device initially transmits a request for the changed layer, and the server 100 initially transmitted the changed layer to the model deploy server.

If at least one layer changed between the first neural network model and the second neural network model is not stored in the model deploy server, the model deploy server may receive information about the changed layer from at least one of the other model deploy servers. That is, the embodiment can initially request a changed layer from an external device other than the external device designated by the model deploy server, so that the server 100 transmits the changed layer to the model deploy server designated in the external device requesting the changed layer.

If at least one changed layer between the first neural network model and the second neural network model is stored in the model deploy server, the model deploy server may transmit information on the at least one layer to the external device in operation S940.

Using the model deploy server as described above, overload of the server 100 may be prevented.

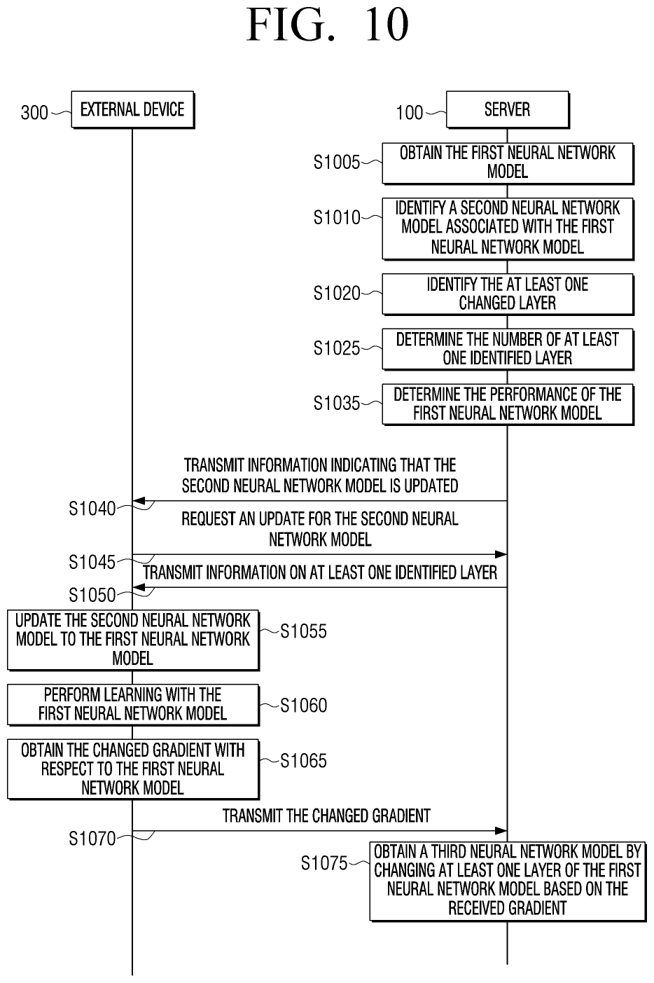

FIG. 10 is a sequence diagram illustrating an operation between a server and an external device according to an embodiment of the disclosure.

Referring to FIG. 10, the server 100 may obtain the first neural network model in operation S1005. The first neural network may be a neural network model in which the at least one layer is changed from the second neural network model.

In operation S1010, the server 100 may identify a second neural network model associated with the first neural network model. Specifically, the server 100 can identify a second neural network model associated with the first neural network model using the metadata file included in the first neural network model, or identify a second neural network model associated with the first neural network model using the metadata file and the index file included in the first neural network model.

If the second neural network model associated with the first neural network model is not identified, the server 100 may transmit the entirety of the first neural network model to the external device 300.

If the second neural network model associated with the first neural network model is identified, the server 100 may identify the at least one changed layer in operation S1020. The server 100 may identify at least one changed layer between the first neural network model and the second neural network model using the index file included in the first neural network model. To be specific, by identifying the hash value for at least one changed layer file through the index file included in the first neural network, at least one changed layer may be identified.

If the at least one changed layer is identified, the server 100 may determine the number of at least one identified layer in operation S1025. That is, if the first neural network model and the second neural network model are compared, and the number of changed layer is greater than or equal to a preset value, it may be identified that update of the entirety of the second neural network model is performed, and the server 100 may transmit the entirety of the first neural network model to the external device 300.

If the number of changed layers is not more than a preset value by comparing the first neural network model and the second neural network model, the server 100 can determine the performance of the first neural network model in operation S1035. The server 100 may determine the performance of the first neural network model and the second neural network model to identify whether the first neural network model has improved performance relative to the second neural network model in operation S1035. Specifically, the server 100 can compare the accuracy and loss values of the first neural network model and the second neural network model. The accuracy and loss value of a neural network model are indicative of the performance of a neural network model, and the higher the accuracy, the lower the loss value, the better the performance of the neural network model. As a result of the comparison, if the accuracy of the first neural network model is higher than the accuracy of the second neural network model, and the loss value of the first neural network model is lower than the loss value of the second neural network model, the performance of the first neural network model is identified as being improved compared to the second neural network model.

If the performance of the first neural network model is identified as not being improved over the second neural network model, the server 100 may not transmit information on the changed layer to the external device 300.

If the first neural network model is identified to have improved performance compared to the second neural network model, the server 100 may transmit information indicating that the second neural network model is updated to the external device 300 in operation S1040. When the external device 300 receives information indicating that the second neural network model is updated, the external device 300 can request an update for the second neural network model to the server 100 in operation S1045. The server 100 may transmit information on at least one identified layer to the external device 300 according to the update request in operation S1050.

If the external device 300 receives information on the at least one identified layer, the external device 300 may update the second neural network model to the first neural network model in operation S1055. That is, the external device 300 may identify a layer changed from the former layer of the second neural network model based on the information on the changed layer, and by changing the identified layer to the changed layer, may update the second neural network model as the first neural network model.

The external device 300 may perform learning with the first neural network model in operation S1060. In an embodiment, as the external device 300 uses the first neural network model, the first neural network model may be trained using the method such as the reinforcement learning capable of automatic learning, but the embodiment is not limited thereto, and the first neural network model may be trained by various methods.

The external device 300 may obtain the changed gradient with respect to the trained first neural network model in operation S1065. If the second neural network model is trained through the external device 300, the gradient for the second neural network model may be updated. The gradient denotes an incline indicating a point at which the loss value of the neural network model is minimum, and the less the loss value of the neural network model, the higher the performance of the neural network model. That is, the gradient may be an indicator indicating the learning result of the neural network model.

Once the changed gradient is obtained, the external device 300 may transmit the changed gradient to the server 100 in operation S1070. The server 100 can obtain a third neural network model by changing at least one layer of the first neural network model based on the received gradient in operation S1075. The third neural network model can be a neural network model in which a first neural network model is updated based on a first neural network model trained in an external device.

If the third neural network model is obtained, the server 100 may repeat the above process, thereby transmitting the information on the changed layer between the third neural network model and the first neural network model to the external device 300.

By the various embodiments described above, if the server 100 deploys (transmits) the updated neural network model to the external device 300, the time required for deployment and learning of the neural network model may be shortened.

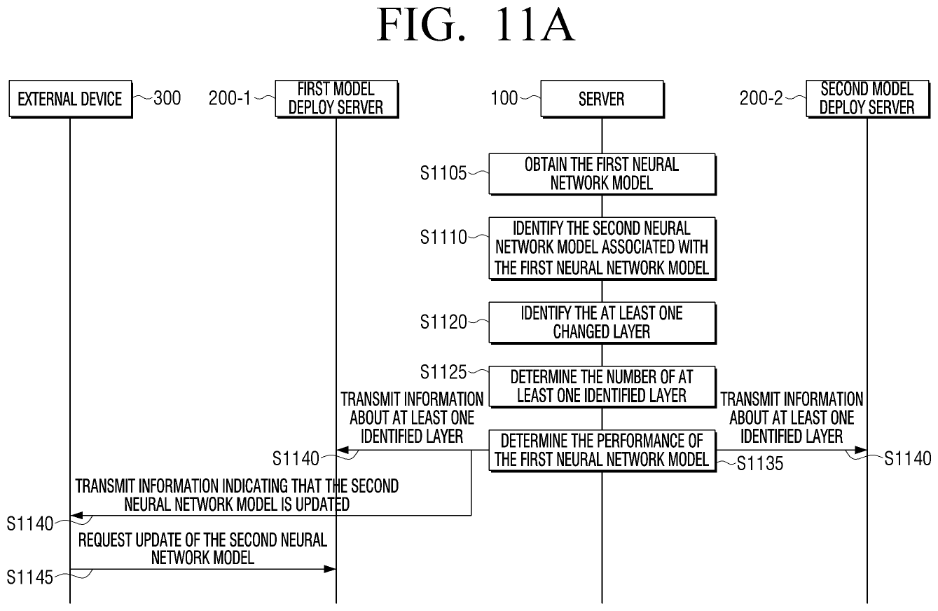

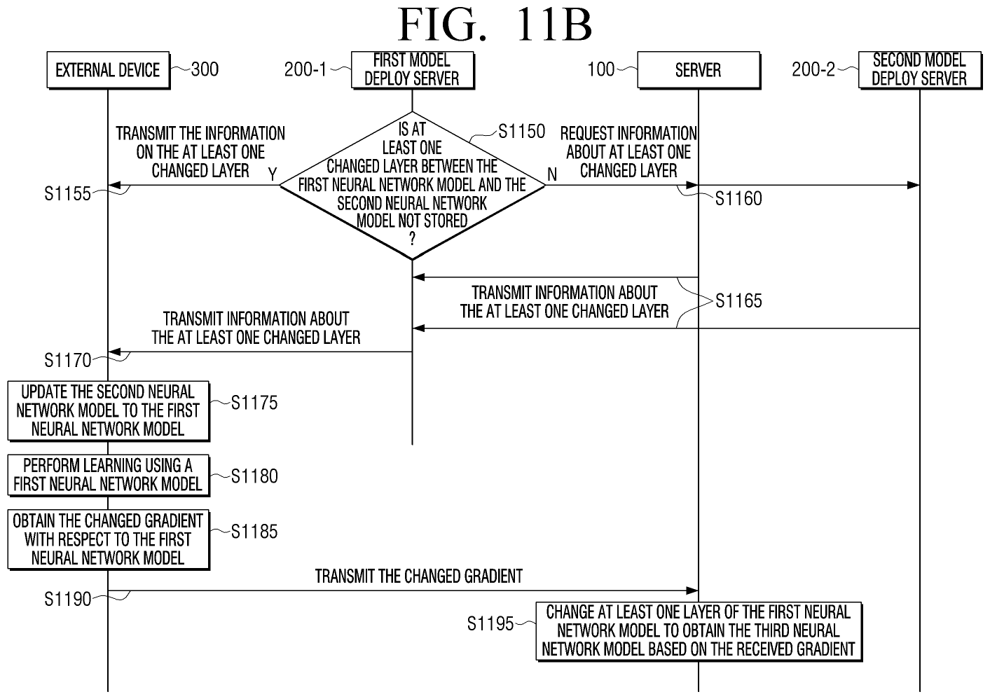

FIGS. 11A and 11B are sequence diagrams illustrating an operation among a server, an external device, and a model deploy server according to various embodiments of the disclosure.

Referring to FIG. 11A, the server 100 may obtain the first neural network model in operation S1105. The first neural network model may be a neural network model in which at least one layer is changed from the second neural network model.

The server 100 may identify the second neural network model associated with the first neural network model in operation S1110. The server 100 may identify the second neural network model associated with the first neural network model using the metadata file included in the first neural network model, or may identify the second neural network model associated with the first neural network model using the metadata file and the index file included in the first neural network model.

If the second neural network model associated with the first neural network model is not identified, the server 100 may transmit the entirety of the first neural network model to the first model deploy server 200-1.

If a second neural network model associated with the first neural network model is identified, the server 100 may identify the at least one changed layer in operation S1120. The server 100 may use the index file included in the first neural network model to identify at least one layer that has changed between the first neural network model and the second neural network model. Specifically, the at least one changed layer can be identified by identifying a hash value for at least one changed layer file through an index file included in the first neural network.

If the at least one changed layer is identified, the server 100 may determine the number of at least one identified layer in operation S1125. If the number of changed layer is greater than or equal to a preset number by comparing the first neural network model and the second neural network model, it may be determined that update of the entirety of the second neural network model is performed, and the server 100 may transmit the entirety of the neural network model to the first model deploy server 200-1.

If the number of changed layers is not more than a preset value by comparing the first neural network model and the second neural network model, the server 100 can determine the performance of the first neural network model in operation S1135 and identify whether the performance is improved compared to the second neural network model. Specifically, the server 100 can compare the accuracy and loss values of the first neural network model and the second neural network model. The accuracy and loss value of a neural network model are indicative of the performance of a neural network model, and the higher the accuracy, the lower the loss value, the better the performance of the neural network model. As a result of the comparison, if the accuracy of the first neural network model is higher than the accuracy of the second neural network model, and the loss value of the first neural network model is lower than the loss value of the second neural network model, the first neural network model can be identified that the performance is improved compared to the second neural network model.

If the first neural network model is identified as not being improved over the second neural network model, the server 100 may not transmit the information on the changed layer to the external device 300.

If the first neural network model is identified to have improved performance compared to the second neural network model, the server 100 can transmit information about at least one identified layer to the first model deploy server 200-1 and the second model deploy server 200-2, and transmit information indicating that the second neural network model is updated to the external device 300 in operation S1140. The embodiment is not limited thereto, and if the first neural network model is identified to have improved performance compared to the second neural network model, the server 100 may transmit information about at least one identified layer to only at least one of the model deploy server of the first model deploy server 200-1 and the second model deploy server 200-2. If the external device 300 receives information indicating that the second neural network model is updated, the external device 300 may request update of the second neural network model to the first model deploy server 200-1 which is the model deploy server designated at the external device 300 in operation S1145. The description will be described with reference to FIG. 11B below.

Referring to FIG. 11B, when the first model deploy server 200-1 receives an update request for the second neural network model from the external device 300, the first model deploy server 200-1 can identify whether at least one changed layer between the first neural network model and the second neural network model is stored in operation S1150. In operation S1140, if the first model deploy server 200-1 does not receive information about the at least one changed layer and the second model deploy server 200-2 receives, the first model deploy server 200-1 can identify that at least one changed layer between the first neural network model and the second neural network model is not stored in the first model deploy server 200-1. In operation S1140, if the first model deploy server 200-1 receives information about the at least one changed layer, the first model deploy server 200-1 can identify that at least one changed layer between the first neural network model and the second neural network model is stored in the first model deploy server 200-1.

If at least one changed layer between the first neural network model and the second neural network model is stored in the first model deploy server 200-1 in operation S1150-Y, the first model deploy server 200-1 may transmit the information on the at least one changed layer to the external device 300 in operation S1155.

If at least one changed layer between the first neural network model and the second neural network model is not stored in the first model deploy server 200-1 in operation S1150-N, the first model deploy server 200-1 can request information about at least one changed layer to the server 100 or the second model deploy server 200-2 in operation S1160. In response to a request for information about the at least one changed layer, the server 100 or the second model deploy server 200-2 can transmit information about at least one changed layer to the first model deploy server 200-1 S1165. The first model deploy server 200-1 can transmit information about the at least one changed layer to the external device 300 in operation S1170.

When the external device 300 receives information on the at least one changed layer, the external device 300 may update the second neural network model to the first neural network model in operation S1175. The external device 300, based on the information on the changed layer, may identify the changed layer from the former layer of the second neural network model and change the identified layer to the changed layer thereby updating the second neural network model to the first neural network model.

In operation S1180, the external device 300 may perform learning using a first neural network model. In one embodiment, as the external device 300 uses the first neural network model, the first neural network model can be trained through a method such as reinforcement learning in which learning can be performed automatically, but the first neural network model can be trained by various methods.

The external device 300 may obtain the changed gradient with respect to the trained first neural network model in operation S1185. If the second neural network model is trained through the external device 300, the gradient associated with the second neural network model may be updated. The gradient denotes an incline indicating a point at which the loss value of the neural network model is minimum, and the less the loss value of the neural network model, the higher the performance of the neural network model. The gradient may be an indicator indicating a learning result of the neural network model.

When the changed gradient is obtained, the external device 300 may transmit the changed gradient to the server 100 in operation S1190. The server 100, based on the received gradient, may change at least one layer of the first neural network model to obtain the third neural network model in operation S1195. That is, the third neural network model may be a neural network model in which the first neural network model is updated based on the first neural network model trained at the external device.

When the third neural network model is obtained, the server 100 may transmit, to the external device 300, information on the changed layer between the third neural network model and the first neural network model to at least one of the first model deploy server 200-1 and the second model deploy server 200-2, by repeating the above process.

Through the model deploy server as described above, the overload of the server 100 may be prevented.

Hereinabove, embodiments of the disclosure have been described with reference to the accompanying drawings. However, this disclosure is not intended to limit the embodiments described herein but includes various modifications, equivalents, and/or alternatives. In the context of the description of the drawings, like reference numerals may be used for similar components.

In this document, the expressions “have,” “may have,” “including,” or “may include” may be used to denote the presence of a feature (e.g., a component, such as a numerical value, a function, an operation, a part, or the like), and does not exclude the presence of additional features.

In this document, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together.

In addition, expressions “first”, “second”, or the like, used in the disclosure may indicate various components regardless of a sequence and/or importance of the components, will be used only in order to distinguish one component from the other components, and do not limit the corresponding components. For example, a first user device and a second user device may indicate different user devices regardless of a sequence or importance thereof. For example, the first component may be named the second component and the second component may also be similarly named the first component, without departing from the scope of the disclosure.

The terms such as “module,” “unit,” “part”, and so on are used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor.

Terms used in the disclosure may be used only to describe specific embodiments rather than restricting the scope of other embodiments. Terms used in the specification including technical and scientific terms may have the same meanings as those that are generally understood by those skilled in the art to which the disclosure pertains. Terms defined in a general dictionary among terms used in the disclosure may be interpreted as meanings that are the same as or similar to meanings within a context of the related art, and are not interpreted as ideal or excessively formal meanings unless clearly defined in the disclosure. In some cases, terms may not be interpreted to exclude embodiments of the disclosure even though they are defined in the disclosure.

The various embodiments described above may be implemented in software, hardware, or the combination of software and hardware. By hardware implementation, the embodiments of the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. In some cases, embodiments described herein may be implemented by the processor 130 of the server 100. According to a software implementation, embodiments of the disclosure, such as the procedures and functions described herein may be implemented with separate software modules. Each of the above-described software modules may perform one or more of the functions and operations described herein.

The various example embodiments as described above may be implemented with software including instructions stored in the machine-readable storage media readable by a machine (e.g., a computer). A machine is a device which may call instructions from the storage medium and operate according to the called instructions, and may include the server 100 of the embodiments.

When an instruction is executed by a processor, the processor may perform functions corresponding to the instruction, either directly or under the control of the processor, using other components. The instructions may include a code generated by a compiler or executed by an interpreter. For example, the instructions stored in the storage medium may be executed by the processor and the aforementioned controlling method of the electronic device may be executed. For example, as the instructions stored in the storage medium are executed by the processor of the device (or server), the operations of obtaining a first neural network model including a plurality of layers; identifying a second neural network model associated with the first neural network model using metadata included in the first neural network model; based on the second neural network model being identified, identifying at least one changed layer between the first neural network model and the second neural network model; and transmitting information on the at least one identified layer to an external device storing the second neural network model may be performed.

The machine-readable storage medium may be provided in the form of a non-transitory storage medium. Here, “non-transitory” means that the storage medium does not include a signal and is tangible, but does not distinguish whether data is permanently or temporarily stored in a storage medium.

According to embodiments of the disclosure, a method disclosed herein may be provided in a computer program product. A computer program product may be traded between a seller and a purchaser as a commodity. A computer program product may be distributed in the form of a machine-readable storage medium (e.g., a compact disc (CD)-ROM) or distributed online through an application store (e.g., PlayStore™, AppStore™). In the case of on-line distribution, at least a portion of the computer program product may be stored temporarily or at least temporarily in a storage medium, such as a manufacturer's server, a server in an application store, a memory in a relay server, and the like.

Each of the components (for example, a module or a program) according to the embodiments may be composed of one or a plurality of objects, and some subcomponents of the subcomponents described above may be omitted, or other subcomponents may be further included in the embodiments. Alternatively or additionally, some components (e.g., modules or programs) may be integrated into one entity to perform the same or similar functions performed by each respective component prior to integration. Operations performed by a module, program, or other component, in accordance with the embodiments of the disclosure, may be performed sequentially, in a parallel, repetitive, or heuristic manner, or at least some operations may be performed in a different order, omitted, or other operations can be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for controlling of a server, the method comprising:
obtaining a first neural network model including a plurality of layers;
identifying a second neural network model associated with the first neural network model using metadata included in the first neural network model;
based on the second neural network model being identified, identifying at least one changed layer between the first neural network model and the second neural network model; and
transmitting information on the at least one identified layer to an external device storing the second neural network model.

2. The method of claim 1,
wherein the transmitting of the information on the at least one identified layer comprises transmitting the information on the at least one identified layer to at least one model deploy server, and
wherein the external device is configured to receive the information on at least one layer from a model deploy server designated to the external device.

3. The method of claim 2,
wherein based on the external device requesting the information on at least one identified layer to the designated model deploy server,
wherein in response to the information on at least one identified layer being stored in the designated model deploy server, transmitting, to the external device, the information on the at least one identified layer by the designated model deploy server, and
wherein in response to the information on at least one identified layer not being stored in the designated model deploy server, receiving the information on at least one identified layer from the server or other model deploy server different from the designated model deploy server, by the designated model deploy server, and transmitting the information to the external device.

4. The method of claim 1,
wherein the first neural network model and the second neural network model comprise metadata, index data, and model data,
wherein the model data comprise at least one layer divided through an offset table included in the index data, and
wherein the transmitting comprises:
obtaining data for the at least one changed layer from the model data of the first neural network model through the offset table; and
transmitting, to the external device, the metadata, the index data, and the obtained data of the first neural network model.

5. The method of claim 1,
wherein the first neural network model and the second neural network model comprise a metadata file, an index data file, and files for each of at least one layer, and
wherein the transmitting comprises transmitting, to the external device, the metadata file, the index data file, and the files for each of at least one layer of the first neural network model.

6. The method of claim 1, wherein the identifying of the at least one changed layer comprises:
identifying the at least one changed layer by identifying a hash value for the at least one changed layer through index data included in the first neural network.

7. The method of claim 1, wherein, based on the second neural network model being stored in the external device, updating the second neural network model to the first neural network model.

8. The method of claim 1, further comprising:
based on the second neural network model not being identified, transmitting an entirety of the first neural network model to the external device.

9. The method of claim 1, wherein the transmitting of the information on the at least one identified layer to the external device comprises:
based on a number of at least one identified layer being greater than or equal to a preset value, transmitting an entirety of the first neural network model to the external device.

10. The method of claim 1, wherein the transmitting further comprises:
obtaining an accuracy and a loss value of each of the first neural network model and the second neural network model;
comparing the accuracy and loss value of the first neural network model and the accuracy and loss value of the second neural network model; and
based on the accuracy of the first neural network model being greater than the accuracy of the second neural network model, or the loss value of the first neural network model being less than the loss value of the second neural network model, as a result of the comparison, transmitting, to the external device, the information on the at least one identified layer.

11. A server comprising:
a communicator including a circuitry;
a memory including at least one instruction; and
a processor, connected to the communicator and the memory, configured to control the server,
wherein the processor, by executing the at least one instruction, is further configured to:
obtain a first neural network model including a plurality of layers,
identify a second neural network model associated with the first neural network model using metadata included in the first neural network model,
based on the second neural network model being identified, identify at least one changed layer between the first neural network model and the second neural network model, and
transmit information on the at least one identified layer to an external device storing the second neural network model, through the communicator.

12. The server of claim 11,
wherein the processor is further configured to:
transmit the information on the at least one identified layer to at least one model deploy server through the communicator, and
wherein the external device is configured to receive the information on at least one layer from a model deploy server designated to the external device.

13. The server of claim 12, wherein the processor is further configured to:
based on the external device requesting the information on at least one identified layer to the designated model deploy server,
in response to the information on at least one identified layer being stored in the designated model deploy server, transmit, to the external device, the information on the at least one identified layer by the designated model deploy server, and
in response to the information on at least one identified layer not being stored in the designated model deploy server, receive the information on at least one identified layer from the server or other model deploy server different from the designated model deploy server, by the designated model deploy server, and transmit the information to the external device.

14. The server of claim 11,
wherein the first neural network model and the second neural network model comprise metadata, index data, and model data,
wherein the model data comprise at least one layer divided through an offset table included in the index data, and
wherein the processor is further configured to:
obtain data for the at least one changed layer from the model data of the first neural network model through the offset table, and
transmit, to the external device, the metadata, the index data, and the obtained data of the first neural network model through the communicator.

15. The server of claim 11,
wherein the first neural network model and the second neural network model comprise a metadata file, an index data file, and files for each of at least one layer, and
wherein the processor is further configured to transmit, to the external device, the metadata file, the index data file, and the files for each of at least one layer of the first neural network model through the communicator.

16. The server of claim 11, wherein the processor is further configured to:
identify the at least one changed layer by identifying a hash value for the at least one changed layer through index data included in the first neural network.

17. The server of claim 11, wherein, based on the second neural network model being stored in the external device, the external device is configured to:
update the second neural network model to the first neural network model based on the received information on at least one layer.

18. The server of claim 11, wherein the processor is further configured to:
based on the second neural network model not being identified, transmit an entirety of the first neural network model to the external device through the communicator.

19. The server of claim 11, wherein the processor is further configured to:
based on a number of at least one identified layer being greater than or equal to a preset value, transmit an entirety of the first neural network model to the external device through the communicator.

20. The server of claim 11, wherein the processor is further configured to:
obtain an accuracy and a loss value of each of the first neural network model and the second neural network model,
compare the accuracy and loss value of the first neural network model and the accuracy and loss value of the second neural network model, and
based on the accuracy of the first neural network model being greater than the accuracy of the second neural network model, or the loss value of the first neural network model being less than the loss value of the second neural network model, as a result of the comparison, transmit, to the external device, the information on the at least one identified layer through the communicator.

21. The server of claim 20, wherein the processor is further configured to, when the accuracy of the first neural network model being less than or equal to the accuracy of the second neural network model, or the loss value of the first neural network model being greater or equal to the loss value of the second neural network model, prevent transmission of the information on the at least one identified layer to the external device.

22. The server of claim 11,
wherein the processor is further configured to, when the second neural network model is trained through the external device, update a gradient for the second neural network model,
wherein the gradient comprises an incline indicating a point at which a loss value of a neural network model is a minimum, and
wherein, when the loss value of the neural network model is less than the minimum, performance of the neural network model increases.

23. The server of claim 22, wherein the processor is further configured to:
receive the updated gradient from the external device, and.
change at least one layer in the second neural network model based on the updated gradient to generate the first neural network model.
